(19) United States
(12) Patent Application Publication
(10) Pub. No.: US 2003/0199303 A1
(43) Pub. Date: Oct. 23, 2003

(54) Lotto type game having multiple chance cards and multiple tier play

(76) Inventor: Steven A. Weiss, Henderson, NV (US)

Correspondence Address: ROY A. EKSTRAND, 3158 REDHILL AVE. STE 150, COSTA MESA, CA, 92626, US

(21) Appl. No.: 10/128,881

(22) Filed: Apr. 23, 2002

(51) Int. Cl. A63F 13/00

(52) U.S. Cl. 463/17

(57) ABSTRACT

A game play device supports a video display and processor control unit together with a plurality of user inputs. The control unit operates and plays a lotto type game having six cards arranged in pairs each of which defines a three-by-five number matrix. A plurality of ball spaces are positioned across the upper display and correspond to the numbered balls selected in game play. A second plurality of ball spaces corresponding to the colored and letter bearing balls of the game play are also positioned upon the display. During game play, a random number generator provides three-by-five number sets for each card and selects a random group of numbers from a number pool. The game play also selects a random number of colored letter bearing balls to be inserted during game play. Thereafter, numbered balls and letter bearing colored balls are presented and fill the spaces within the display. As each numbered ball is presented, the corresponding numbers on any of the three-by-five cards is illuminated. At the completion of game play, winning is determined based upon a pay table corresponding to the number of illuminated number matches on each card.

### FIELD OF THE INVENTION

This invention relates generally to games and gaming apparatus and particularly to games utilized in lotto type gaming activities.

### BACKGROUND OF THE INVENTION

Lottos and lotto type games are well known in the art. With the proliferation of digital electronic technologies, lotto type games and gaming devices have enjoyed substantial development in game creativity and display complexity.

The heart of most, if not all, lotto type games utilizes one or more random number generators which cooperate to control the game script or sequence of events which in turn defines game play. For the most part, lotto game play involves matching a sequence or group of numbers to a pro-established winning number or number sequence.

Lotto game systems have been developed which use “stand-alone” devices having a central processor and memory together with a display monitor and audio system. The entire apparatus resides within a housing or cabinet which in turn supports conventional gaming apparatus such as coin and bill inputs, credits/payment systems and game play input buttons and keys.

Operating in accordance with the internal gaming software, the processor responds to user play inputs and choices such as those relating to wagering, game selection and game play initiation to generate lotto type game events based upon random number generation and game rules. Concurrently, the processor provides video display intended to both communicate game progress and results and to amuse and entertain the game player. In most lotto type gaming devices, audio effects are also provided to further enhance the game playing experience.

In many lotto type games, basic number matching is employed during game play in which the player pays for a chance at winning in the form of a randomly generated set of numbers. In such games, winning is based upon all, or a portion of, a previously established number set. In other lotto type games, secondary games such as bingo-style games or other known games such as card games or the like are played. In such case, winning is based upon attaining predetermined “payout” patterns.

To further enhance interest in lotto type games, practitioners in the gaming arts often combine the stand-alone aspects of a gaming device with participation in one or more broader games such as state wide jackpots or the like. This broader lotto participation is typically achieved by coupling a great number of stand-alone gaming devices to a common communication apparatus for participation in the broader game. Often communication facilities such as the internet or local area networks are utilized to facilitate this broader game participation.

Despite the substantial advances in lotto type gaming devices and the games played therewith, there remains a persistent challenge for practitioners in the art in attempting newer and more exciting games in order to maintain player interest. This challenge in turn creates a virtually insatiable need in the art for evermore improved, interesting, exciting and entertaining lotto type games.

### SUMMARY OF THE INVENTION

Accordingly, it is a general object of the present invention to provide an improved lotto-style game. It is a more particular object of the present invention to provide an improved lotto-style game which dramatically enhances the play value and entertainment appeal of participation in lotto gaming. It is a still more particular object of the present invention to provide an improved lotto game which facilitates simultaneous play of multiple chance cards and simultaneous multiple tier game play.

In accordance with the present invention there is provided a lotto game played upon a game player having user input means and display means, the lotto type game comprising: providing an image having a ball presentation, a plurality of numbered ball spaces, a plurality of lotto ball spaces and a plurality of number cards each having a plurality of number squares thereon; defining a first range of numbers; randomly selecting a first plurality of numbers from the first range of numbers and placing the numbers on the number squares to fill the cards; randomly selecting a second plurality of numbers from the first range of numbers to establish a sequence of ball numbers; presenting a plurality of numbered balls upon the ball presentation, the numbered balls having the sequence of ball numbers thereon; indicating each match between the ball numbers and the numbers on the number squares as each numbered ball is presented; and determining game results based upon the numbers of the matches on each of the number cards.

From another perspective, the present invention provides lotto game constructed to be played on a game player having player input means and display means, the lotto game comprising: displaying an image to the player which includes a plurality of number cards each having a plurality of randomly generated numbers; displaying a plurality of numbered ball each having a randomly selected number thereon, the randomly generated numbers for the number cards and the randomly selected numbers for the numbered balls being selected from the same range of numbers; indicating each match on the number cards for each numbered ball as it is displayed; displaying a plurality of letter-bearing balls selected between zero and a predetermined maximum number randomly interspersed among the numbered balls; placing a replica of each numbered ball presented upon the image; determining a win or loose event for each number card based upon the number of the indicated matches on each card; and indicating each number card having a winning number of matches thereon.

From a still further alternate perspective, the present invention provides a lotto type game played upon a game player having user input means and display means in which the lotto type game comprises: a basic game, having defined basic game winning odds, played upon the game player; a lotto game, having defined lotto game winning odds; and player option, selected by user input, for playing the basic game alone at the basic game winning odds or for playing the basic game and the lotto game in combination at odds determined by the combination of the basic game winning odds and the lotto game winning odds.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of an illustrative lotto type gaming device constructed in accordance with the present invention;

FIG. 2 sets forth a block diagram of a game control apparatus utilized in accordance with the present invention lotto type game;

FIG. 3 sets forth an illustrative display screen used in playing the present invention lotto style game;

FIG. 4 sets forth a generalized flow diagram of user play of the present invention lotto-type game;

FIGS. 5A through 5E taken together set forth a flow diagram of the present invention lotto type game;

### DESCRIPTION OF THE PREFERRED EMBODIMENTS

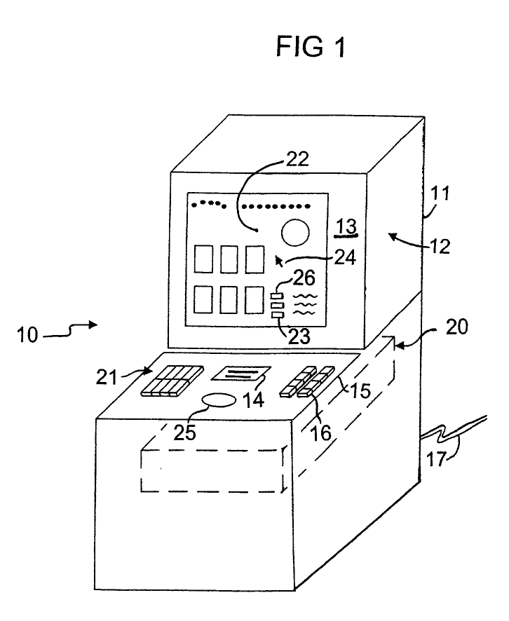

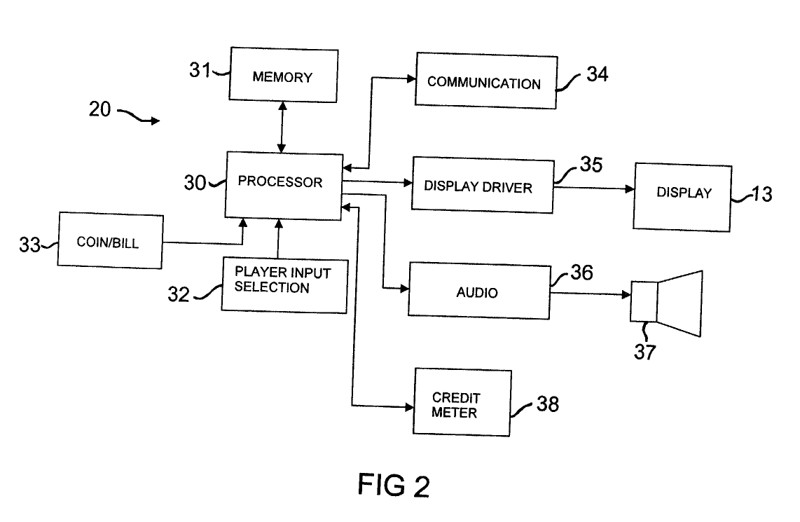

FIG. 1 sets forth a perspective view of a game device suitable for playing the present invention lotto type game and generally referenced by numeral 10. Game device 10 includes a large cabinet 11 defining an interior cavity 12 within which a digital electronic control unit 20 is supported. Control unit 20 is set forth below in FIG. 2 in greater detail. However, suffice it to note here that control unit 20 responds to user inputs and controls the generation of random numbers and play activities utilized in playing the present invention game. Gaming device 10 further includes a display monitor 13 upon which a game image 22 is formed. A plurality of player inputs 21 are also supported upon cabinet 11 and may include a conventional mouse or track ball element 25 utilized in moving and actuating a cursor 24 formed on game image 22. Game image 22 may further include a plurality of touch screen pads 26 or selection pads 23. The latter may be activated by positioning cursor 24 and “clicking” in accordance with conventional fabrication techniques.

In operation, and as is set forth below in greater detail, the player initiates game play activity by inputting a quantity of coins or bills into a coin/bill receiver 14. Control unit 20 responds to the amount of money deposited by the player to establish the players credit account as set forth below. In response to the players money deposit, control unit 20 initiates the set up phase of game play in which game image 22 presents various questions and selection options for the player. The player utilizes player inputs 21 as well as one or more game play buttons 15 to establish the important elements of game play such as the number of cards to be played and the wager to be placed upon the particular game. Thereafter, the player commences game play by pressing play button 16 to which control unit 20 responds and the game play game described below is carried forward.

It will be apparent to those skilled in the art that the distribution of player inputs between actual input controls such as player inputs 21, 25, 15 and 16 shown by way of example upon control unit 20 as well as the use of touch screen inputs such as touch screen pad 26 and mouse pad 23 is a matter of design choice. The important aspect with respect to the present invention is the ability of gaming device 10 to facilitate player input of the various game conditions, wager, etc. for use by control unit 20 in carrying forward game play.

Once game play is initiated, control unit 20 carries forward the gaming activity set forth and described below in greater detail. At the conclusion activity, the gaming device provides game results and payouts, if any, to the game player. In accordance with an important aspect of the present invention set forth below in greater detail, the present invention lotto type game is carried forward on game device 10 in a manner which provides substantial entertainment and amusement value to the player. This in turn motivates additional participation by the player and facilitates enjoyment of the game activity. Gaming device 10 operative utilizing the present invention game residing within control unit 20 is fully capable of stand-alone lotto type game activity. However, the present invention game may be fully enjoyed utilizing participation in additional broader game activities such as state wide lottery games or the like. In such case, a communication line 17 operatively coupled to control unit 20 through communication apparatus 34 (seen in FIG. 2) may be utilized to couple gaming device 10 to other gaming devices and/or a master gaming device via conventional communication apparatus such as the internet or a dedicated local area network as desired.

FIG. 2 sets forth a block diagram of control unit 20 utilized within gaming device 10. Control unit 20 is fabricated in accordance with conventional fabrication techniques typical of digital electronic control apparatus. Accordingly, control unit 20 includes a processor 30 which, may for example, comprise a conventional micro processor of the type readily available in the art. Control unit 20 further includes a memory 31 operatively coupled to processor 30 together with a player input and selection apparatus 32 also coupled to processor 30. Player input selection apparatus 32 is representative of a variety of player input selection devices 32 is representative of a variety of player input selection devices such as the above mentioned dedicated buttons, mouse and cursor, as well as touch screen input apparatus. Control unit 20 further includes a conventional coin and bill receiver 33 which allows processor 30 to establish and maintain a players credit account within a credit meter 38. Control unit 30 further includes a display driver 35 operatively coupled to a video display unit 13. Display unit 13 operates to provide video displays such as game image 22 (seen in FIG. 1). In addition, control unit 20 includes a conventional audio system 36 operatively controlled by processor 30 and coupled to a suitable output device such as speaker 37.

In operation, processor 30 cooperates with the stored game software within memory 31 to carry forward the play of the present invention game described below in greater detail. In carrying forward this game play, processor 30 responds to player input selections via input selection unit 32 and coin and bill receiver 33. Credit meter 38 is utilized under processor control-to establish and maintain credit account of the player during the course of one or more rounds of game play. Finally, processor 30 utilizing the stored instruction set within memory 31 operates display driver 35 to provide appropriate images during game play upon display 13 and operates audio system 36 to provide appropriate game sounds utilizing during game play to further enhance game appeal. In addition, communication unit 34 may operate in the event the game system is not operative in a stand alone environment to communicate between processor 30 and the remainder of the master gaming system under play.

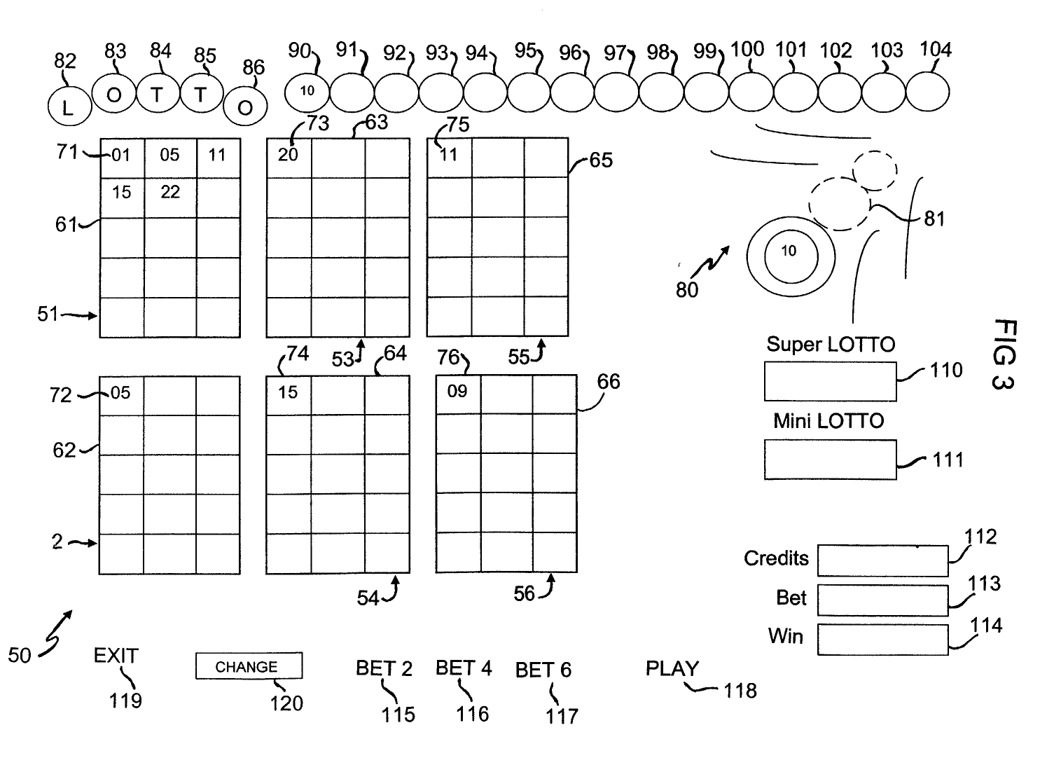

FIG. 3 sets forth an illustrative image screen utilized in carrying forward the present invention game play. It will be apparent to those skilled in the art that while the graphic character selected for the game screen shown in FIG. 3 has proven to be highly interesting and exciting, other arrangements of image elements and display which differ from the display screen shown in FIG. 3 may be utilized without departing from the spirit and scope of the present invention lotto type game. Thus, FIG. 3 will be understood to be illustrative and not limiting in any fashion.

More specifically, FIG. 3 sets forth a game display screen utilized in the present invention lotto type game generally referenced by numeral 50. Display screen 50 includes a plurality of numbered cards 51, 52, 53, 54, 55, 56. Cards 51 through 56 are arranged in vertical pairs. Each numbered card defines a three column by five row matrix of squares 61, 62, 63, 64, 65, and 66 respectively. Each of squares 61 through 66 supports a number randomly selected in the manner described below. Suffice it to note here that numbers are selected from a pool of numbers one through twenty five and are selected in a manner in which no duplication of numbers occur within a given card. Thus, squares 61 of card 51 each defines number 71 while squares 62 of card 52 define numbers 72. Similarly, squares 63 of card 53 define numbers 73 while squares 64 of card 54 define numbers 74. Finally, squares 65 of card 55 define numbers 75 while squares 66 of card 56 define numbers 76. For further convenience in the present invention game, the vertical pairs of cards are combined as a unit in the betting process set forward below. Suffice it to note here that a player choice of player two cards causes cards 51 and 52 to be played while selecting a bet of four cards causes the further addition of cards 53 and 54 into play and finally, selection of betting six cards by a player causes all cards 51 through 56 to be played during the next game play.

Accordingly, display screen 50 includes an icon 115 for a two card bet, an icon 116 for a four card bet, and an icon 117 for a six card bet. As mentioned above, display screen 50 may include a conventional touch screen technology for making the two, four or six card bet choice. Alternatively, player inputs 21 (seen in FIG. 1) may be provided as conventional push buttons for two, four or six card selections. Similarly, a change card numbers icon 120 is provided together with an exit icon 119, and a play icon 118. As with icons 115 through 117, icons 118, 119 and 120 may be touch screen technology icons in which the player simply touches the icon on display screen 50 to provide selection or alternatively may comprise dedicated button inputs within inputs 21 of game device 10 shown FIG. 1. In either case, the important aspects with respect to the present invention game play remain the same. Icon 120 is provided to allow the player to change the randomly selected numbers on number cards 51 through 56. Actuation of the change card feature of the present invention game houses the game processor to randomly select new groups of fifteen numbers for each of cards 51 through 56 from the available pool of numbers one through twenty five in the manner described below. In the event icon 119 is activated, the game play is exited and the system pays out any remaining credits which the player has accumulated or not yet used during game play.

Display screen 50 further includes a super lotto number 110 and a mini lotto 111. Super lottos 110 and 111 relate to play of the present invention game in a broader context rather than simply a stand alone activity. Display screen 50 further includes a credits indicator 112 which sets forth the total amount of money within the players accumulated account together with a bet indicator 113 which sets forth the amount wagered by the player in accordance with the selection of number of cards to be played and a win amount indicator 114 which sets forth the winnings per game of player at the conclusion of game play. As would be anticipated, each bet amount is debited from the players credit and each win amount is added to the players credit to maintain an active running totals of credits.

In further accordance with the present invention game play, display screen 50 includes a graphically depicted ball shute 80 which graphically depicts the emergence of a succession of numbered balls such as ball 81 shown in its fully exposed position. Dashed line depictions of ball 81 behind ball 81 within ball shute 80 are intended to illustrate the graphically simulated forward emergence of ball 81 from shoot 80. In further accordance with the present invention game play, display screen 50 includes a plurality of linearly arranged ball positions 90 through 104. Thus, a total of fifteen ball positions are shown in a linear arrangements which are successively occupied by images of each numbered ball as it emerges from ball shoot 80. Thus, in the illustration shown in FIG. 3, ball 81 bearing a number 10 has emerged from ball shoot 80. Accordingly, position 90 is shown occupied by a ball bearing the number 10. As each successive numbered ball emerges from ball shoot 80, it corresponding depiction of the numbered ball is placed within the next unoccupied position in the array of positions 90 through 104. By way of illustration, the next ball to emerge from ball shute 80 will then be replicated at position 91 and so on until all 15 balls selected randomly by the system processor in the manner described below have been shown to emerge from ball shute 80 and are shown to be depicted in positions 90 through 104 filing out the linear array.

In addition to the depiction of numbered balls emerging from shoot 80, the game processor in a random fashion as described below may interleave additional colored “lotto” balls. In any given game play as described below, a number from zero to five is randomly selected for a given game and a corresponding number of lotto balls are interleaved among the fifteen balls which emerge from ball shoot 80. In a similar fashion to the numbered balls, the emergence of a lotto ball characterized by a color and letter combination is replicated at the corresponding position of positions 82 through 86 of display screen 50. Each lotto ball defines a particular color and bares a particular letter from the word lotto. Thus, for example, the five lotto balls 145 comprise one bearing the letter L, two bearing the letter O and two bearing the letter T. In addition, a color is assigned to each lotto ball. The L ball is assigned a blue color, the first O ball is assigned an aqua color, the first T ball is assigned a green color, the second T ball is assigned a yellow color and the second O ball is assigned a red color. The depictions at positions 82 through 86 of display screen 50 correspond to these letter and color combinations.

The present invention lotto type game provides a number of novel features and advantages beyond the basic game found in ball number generation and number matching. The present invention lotto type game enhances the basic game by adding a lotto feature which provides at least two new methods of winning. That is to say that the number of lotto balls themselves define a further pay event and events arising in the basic game and one or more lotto balls define further pay events.

The inventive enhancement of a basic game provides several advantages. For example, player enjoyment is increased because players have additional winning or pay events to “root” for in connection with the lotto balls. Further, as mentioned above, players have more ways to win. They can win within the basic game as well enjoy winning (pays) due to one or more lotto balls and/or winning (pays) based upon the combination of winning events in the basic game and lotto balls. Operators of gaming systems enjoy the ability to attach very large (lottery-size) jackpots to basic games that have naturally smaller odds. For example, an operator can offer a large jackpot for the combination of a player winning the basic game at 10,000 to 1 together with having all five lotto balls in the same winning game.

Since the total odds of winning the larger lottery-size jackpot are defined by the odds in the basic game and the odds in the lotto ball generation, different basic games may be allowed to use the combination game method of the present invention in competing for the same lottery-size jackpot. The overall winning odds for basic games having different odds may be equated by appropriate adjustment of the lotto ball odds. A basic game having 5,000 to 1 odds may, for example, be equated to a basic game having 10,000 to 1 odds by doubling the lotto ball odds in the first basic game, and so on.

The novel concepts of multiple pays and combined pays within the present invention lotto type game means that a number of different basic games may be combined with suitably adjusted lotto ball combinations to compete for a common jackpot at equal overall odds of winning.

The present invention lotto type game gives the player the option of participating solely in the basic game or in the combinations of basic game and lotto ball enhancements. In the embodiment set forth herein, this option is selected by the players wager.

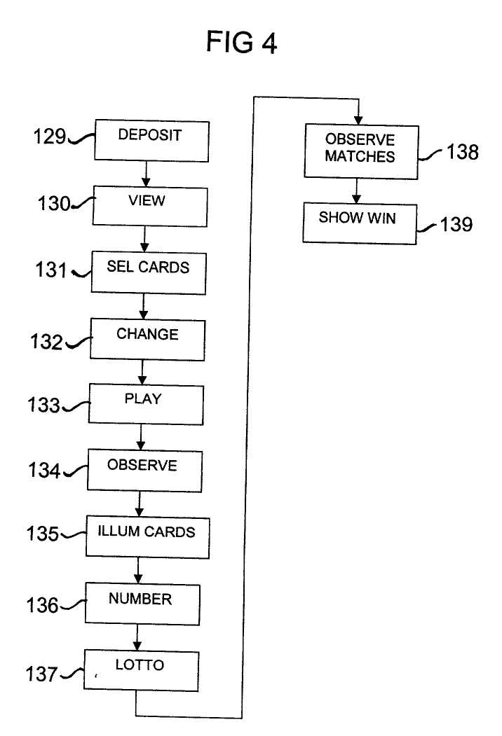

FIG. 4 sets forth a generalized flow diagram of the game play of the present invention game as observed by a player. The game play flow of the present invention game set forth in FIG. 4 is best understood with simultaneous reference to FIGS. 3 and 4. Accordingly, game play is initiated following the players deposit of the desired money amount to be played at step 129. Correspondingly in FIG. 3, credit amount 112 registers this deposited amount together with any previously accumulated deposit amounts to provide a current credit total. Next at step 130, the player views display screen 50 which initially has display spaces 82 through 86 and 90 through 104 vacant. In addition, cards 51 through 56 on display screen 50 bare randomly selected numbers on each of their respective fifteen square matrices. In addition, the current amounts available in super lotto amount 110 and mini lotto amount 111 are also shown on display screen 50. Thereafter, at step 131, the player selects either two, four or six cards to be played. If the player selects two cards, the amount wagered at bet number 113 is one hundred dollars and cards 51 and 52 are shown in play while cards 53 through 56 are shown “no play”. Similarly, a selection of bet four cards wagers two hundred dollars at bet amount 113 and indicates cards 51 through 54 are in play while cards 55 and 56 are indicated “no play”. Finally, a selection of bet six cards changes bet amount 113 to three hundred dollars and causes cards 51 through 56 to be indicated as in play. It will be apparent to those skilled in the art that the dollar amounts associated with card combinations are a matter of design choice and different amounts as well as different groupings of cards played may be utilized without departing from the spirit and scope of the present invention.

At step 132, the player may elect to activate icon 120 on display screen 50 causing a change of randomly selected numbers on each of cards 51 through 56. It should be noted that the exercise of change number option at step 132 is exercisable at any time prior to the initiation of game play and need not follow the selection of the number of cards to be played.

Once the above selections have been made, the game play moves to step 133 at which the player has activated play icon 118 of display screen 50 causing the start of game play. At step 134, the player observes the sequence of random numbered balls emerging sequentially from ball shute 80 of display screen 50 and their corresponding accumulation among positions 90 through 104 thereof. As mentioned above, a random number of color and letter bearing lotto balls randomly selected from numbers zero to five is also interspersed within the series of randomly selected numbered balls emerging from ball shute 80 during game play. As game play progresses, any interspersed colored lotto ball is appropriately positioned within positions 82 through 86 of display screen 50. In addition, as each numbered ball emerges at ball shoot 80, any number square on any number card in play is also illuminated. For example, in the event a ball bearing the number zero-one emerges from ball shute 80 then any square on any one of cards 51 through 56 which is in play bearing the number zero-one will be illuminated. This process continues until fifteen numbered balls have emerged from ball shute 80 and then placed within positions 90 through 104. Correspondingly, any colored lotto balls which emerged during the game are also placed at positions 80 through 86. These depictions occur at steps 136 and 137 as the game is played.

In accordance with an important aspect of the present invention, the total number of balls bearing numbers one through twenty five emerging from ball shute 80 remains the same regardless of the number, if any, of lotto balls injected into the ball sequence by the game processor. Stated more simply, lotto balls do not displace a numbered ball in the sequence of numbered balls selected by the random number generator of the processor.

At step 138, the illuminated matched numbers on cards 51 through 56 are then counted for the number of matches on a given card. If a given card includes a number of matches greater than a predetermined number such as ten, the card numbers are blinked in an audible tone is produced at step 139 indicating a winning event. Thereafter, the winning bet is added to the players credits and game play is complete.

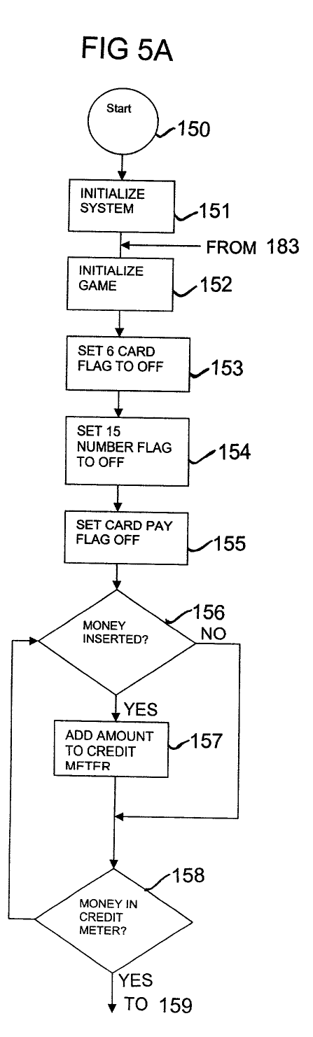

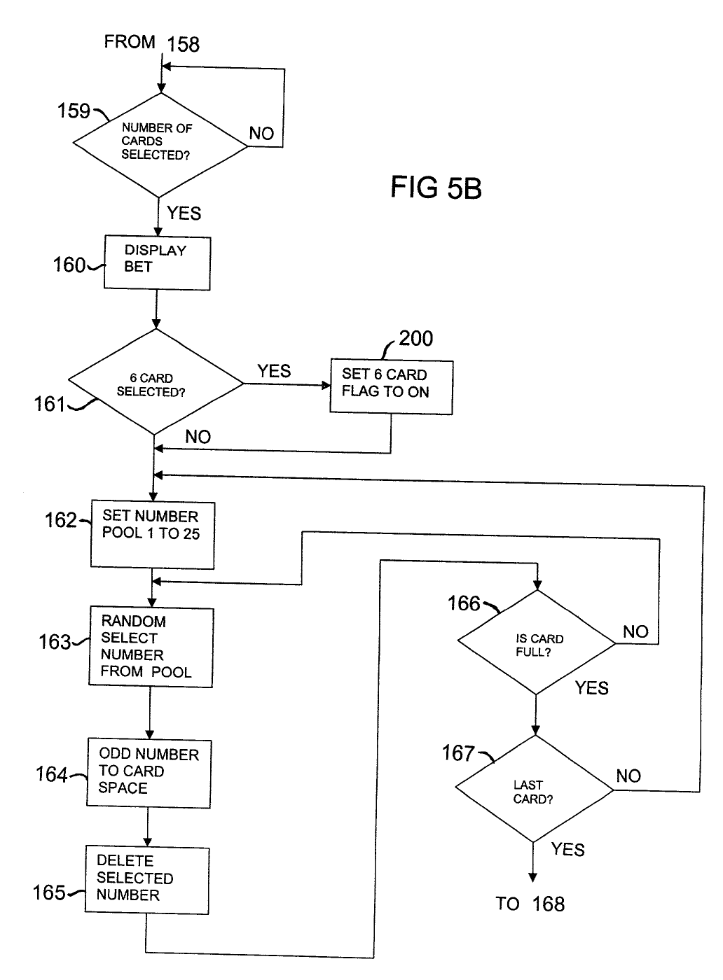

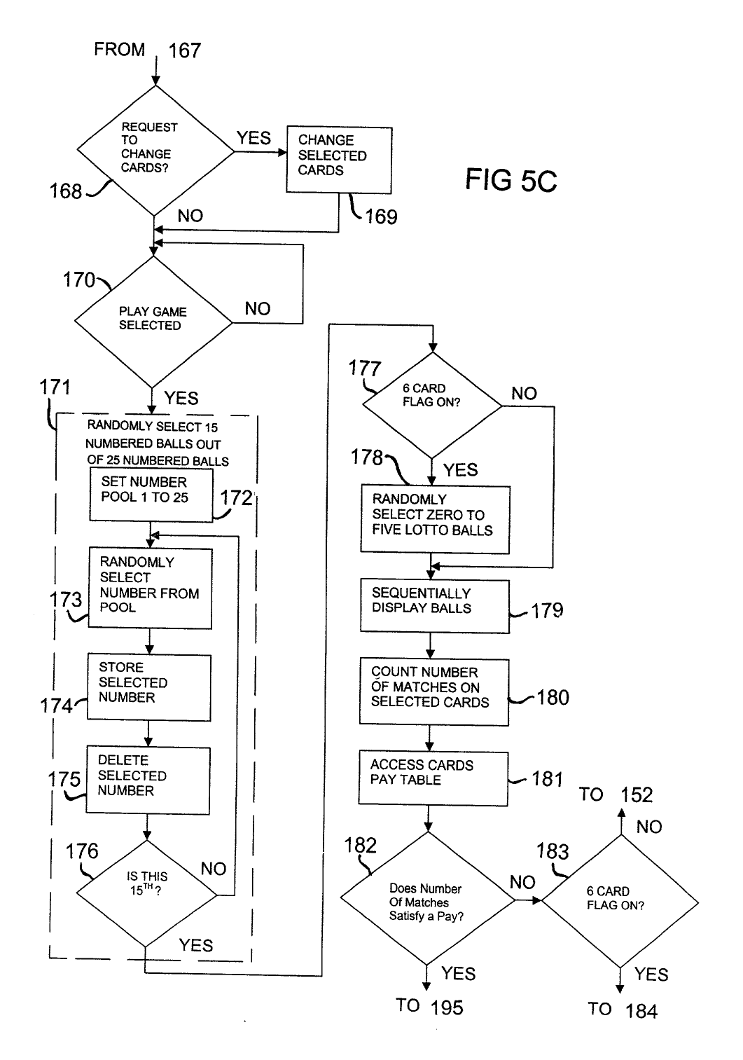

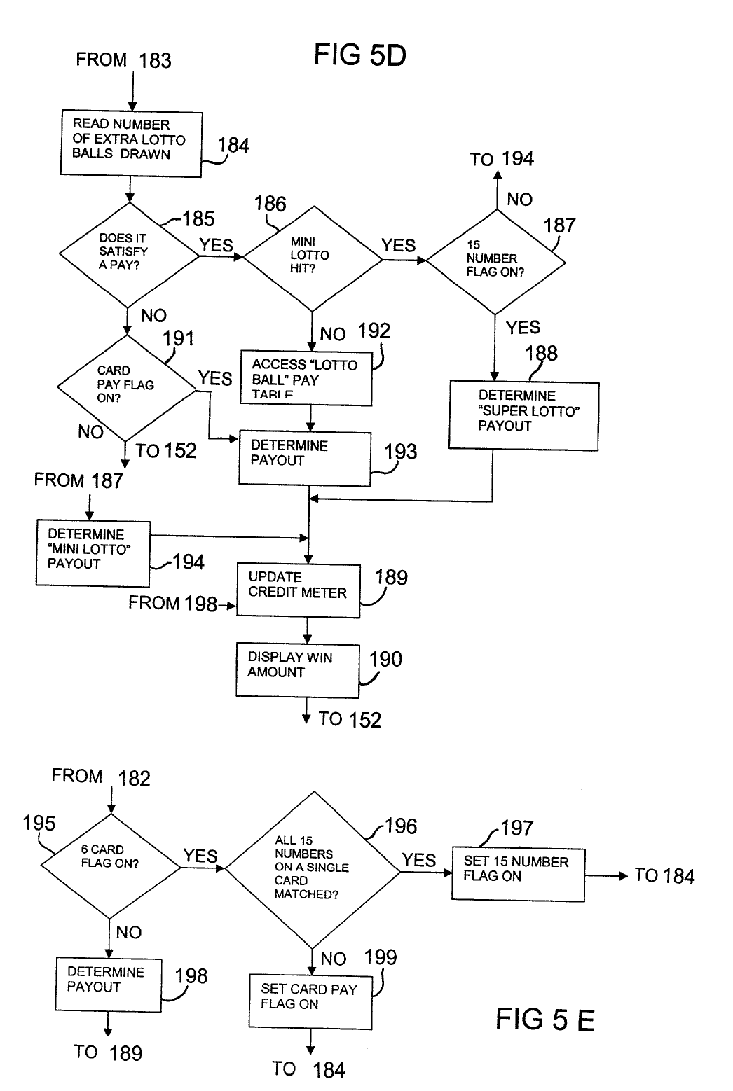

FIGS. 5A through 5E taken together set forth a flow diagram of the present invention lotto type game. With specific reference to FIG. 5A, the game play begins at a power up step 150 followed by a step 151 in which the main system is initialized. Activities carried forward during the initialization of the main system include clearing prior cells and clearing previous money accounts in the credit meter and so on. Thereafter, at step 152, the game itself is initialized and activities such as prior game status are cleared. At step 153, the six card flag is set to off which avoids accidental six card betting in the new game. At step 154, the fifteen number flag is set to off which avoids accidental indication of fifteen matching numbers. At step 155, the card pay flay is set to off. At step 155, the previous game is now clear and the system is initialized. At step 156, the system checks for money insertion by the player. In the event money is inserted, the system moves to step 157 and adds the inserted amount to the players credit meter. In the event money is not inserted, the system moves directly to step 158. At step 158, a determination is made as to whether is present in the credit meter. If not, the system returns to step 156. Once money is present in the credit meter however, the system moves to step 159 shown in FIG. 5B.

In FIG. 5B at step 159, a determination is made as to whether the player has selected the number of cards to be played. It will be recalled in the above example that the player is able to select two, four or six cards for active play in the game. It will also be recalled that the bet or wager placed by the player is determined in an amount corresponding to this card selection. Accordingly, at step 160, the system displays the game bet based upon the number of cards selected. In the above example, selection of two cards provides a bet of one hundred dollars while selection of four cards produces a bet of two hundred dollars and a selection of all six cards produces a bet of three hundred dollars. Thereafter, the system determines at step 161 whether six cards have been selected as a play option. In the event six cards have been selected, the system moves through step 162 setting the six card flag to on. Within the game play scenario, this flag setting makes the player eligible for additional participation in the super lotto and mini lotto bonus payouts described above.

At steps 162 through 167, the system goes through a repetitive routine in which the cards are given the randomly generated numbers which fill out their squares prior to game play. More specifically, at step 162, the number pool is set for numbers one through twenty five. At step 163, a number is randomly selected from the number pool and at step 164 the selected number is added to a card space. Thereafter, at step 165, the selected number is deleted from the number pool. This is in accordance with an important aspect of the present invention which ensures that numbers may not be repeated upon a given card. Once the number selected is deleted at step 165, a determination is made at step 166 as to whether the current card is full. If the current card is not full, the system returns to step 163 and randomly selects another number from the existing number pool. Once the card is determined at step 166 to be full, the system moves to step 167 for a determination as to whether the filled card is the last card. If not, the system returns to step 162 setting a new number pool and repeating steps 162 through 166. At step 167 once a determination is made that the filled card is the last card, the system moves to step 168 in FIG. 5C.

In FIG. 5C at step 168, a determination is made as to whether the player has selected the option to change the numbering on the cards presented on the display screen. In the event the user elects to change card numbering, the system moves to a change card option step 169 in which the above described numbering steps 162 through 167 shown in FIG. 5B are repeated. Thereafter, the system returns to step 168. If the player again selects a change card option, step 169 and the above described numbering set is repeated. This process continues until a determination is made at step 168 that the user is no longer electing to change the card numbering. The system then moves to step 170 and awaits the initiation of game play by the player. Thereafter, at a step 170, the system randomly selects fifteen numbered balls from the available pool of numbers one through twenty five. Step 171 defines a number selection routine which is set forth in detail in steps 172 through 175. Of importance to note in steps 172 through 176 is the manner in which random number selection from numbers one through twenty five is carried forward in an operation which avoids duplication of numbers.

More specifically, within step 171 the number pool is set to numbers one through twenty five at step 172. Thereafter, at step 173, a number is randomly selected from the number pool. Next at step 174, the selected number is stored after which at step 175 the selected number is deleted from the available number pool. At step 176, a determination is made as to whether the last selected number was the fifteenth or final number required. In the event the selected number is not the final number, the system returns to step 173 and steps 173 through 175 are again repeated. It will be noted that at step 173, the number pool is no longer the full number pool in step 172 due to the deletion of selected number or numbers at step 175. This process continues until the selected number is the fifteenth number. Thereafter, the system moves to step 177 and a determination is made as to whether the six card flag has been set to on. If not, the system moves directly to step 179. However, if the six card flag is on then the system moves to a step 178 at which a random number between zero and five is selected for the number of the above described colored lotto balls which will be played. In either event, at step 179 the system sequentially displays each numbered ball and interspersed colored lotto balls, if any, in the manner graphically described in conjunction with FIG. 3. At step 180, following the sequential display of all fifteen numbered balls and any interspersed colored lotto balls, the system counts the number of matches on the cards in play. Once the number of matches per played card has been determined at step 180, the system moves to step 181 accessing the cards pay table. This table is utilized in determining the various payouts for the number of matches. At step 182, a determination is made as to whether a card has satisfied the number of matches for a pay. If a pay is indicated, the system moves to step 195 in FIG. 5D. If however, the cards matches fail to satisfy a pay, a determination is made at step 183 as to whether the six card flag is on. If the six card flag is not on, the system returns to step 152 in FIG. 5A. If however, the six card flag is on, the system moves to step 184 in FIG. 5D.

In FIG. 5D at step 184 the system reads the number of lotto balls drawn during the preceding game play. At step 185, the system determines whether the number of lotto balls satisfies a pay. In the event a pay is satisfied at step 185, the system moves to step 186 to determine whether a mini lotto event has occurred. If a mini lotto hit has occurred, the system moves to step 187 determining whether the fifteen number flag has been set to on. If the fifteen number flag is not on, the system moves to step 194. If however, the fifteen number flag is determined to be on, the system moves to step 188 for a determination of super lotto payout. Thereafter, the system moves to step 189.

If however, at step 186 a determination is made that a mini lotto hit has not occurred, the system moves to step 192 accessing the lotto ball pay table. Thereafter, at step 193, a determination of payout based upon the lotto ball pay table is made and the system progresses to step 189.

In the event a determination is made at step 185 that a pay has not been satisfied by the number of lotto balls, the system moves directly to step 191 for a determination as to whether a card pay flag has been set to on. If no card pay flag has been set, the system returns to step 152 shown in FIG. 5A. If however, a card pay flag is set to on, the system moves to step 193 where a determination of payout is made. At step 194, in response to a determination at step 187 that the fifteen number flag is not set to on, a determination is made as to the mini lotto payout. The system then moves to step 189. At step 189, the various payouts, if any, and the previous wager are utilized in updating the player credit meter. Thereafter, at step 190, the system displays the amount of the players winnings on display screen 50 (seen in FIG. 3) and the system returns to step 152 in FIG. A.

FIG. 5E sets forth the remainder of the system operation following a determination at step 182 in FIG. 5C that the number of matches on a card satisfies a pay amount. Once a determination is made that a number match sufficient to satisfy a pay has been made, the system at step 195 determines whether the six card flag is set to on. If the six card flag is set to on, the system determines at step 196 whether all fifteen numbers on a single card have been matched.

If a fifteen number match has occurred, the system moves to a step 197 setting the fifteen number flag to on and thereafter returns to step 184 in FIG. 5D. If however, a fifteen number match has not occurred on any card, the system moves to step 199 setting the card pay flag to on after which the system returns to step 184 in FIG. 5D.

In the event a determination is made at step 195 that the six card flag is not set to on, the system moves directly to step 198 determining a payout. Thereafter, the system returns to step 189 in FIG. 5D at which the players credit meter is updated.

The foregoing described flow diagrams set forth the basic operation of the present invention game and its novel features. It will be apparent to those skilled in the art that various selection criteria have been chosen in the present example of the present invention game. It will be further apparent to those skilled in the art that such number selections are the result of game designers choice and are not limiting upon the spirit and scope of the present invention. For example, is will be apparent to those skilled in the art that the selection of fifteen numbered balls from a pool of one through twenty five is an element of such design choice and that other numbers of numbered balls may be utilized without departing from the spirit and scope of the present invention. Similarly, the use of the five colored lotto balls is also a matter of such design choice. Further, the selection of cards having three-by-five number matrices as well as the selection of six cards played in pairs may be altered without departing from the spirit and scope of the present invention. It will also be recognized that additional graphics differing from the graphics example in FIG. 3 may be utilized without departing from the present invention. Accordingly, it will be recognized that the present invention sets forth novel game play which provides a maximum of entertainment and amusement while carrying forward the desired lotto participation.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A lotto type game played upon a game player having user input means and display means, said lotto type game comprising:
providing an image having a ball presentation, a plurality of numbered ball spaces, a plurality of lotto ball spaces and a plurality of number cards each having a plurality of number squares thereon;
defining a first range of numbers;
randomly selecting a first plurality of numbers from said first range of numbers and placing said numbers on said number squares to fill said cards;
randomly selecting a second plurality of numbers from said first range of numbers to establish a sequence of ball numbers;
presenting a plurality of numbered balls upon said ball presentation, said numbered balls having said sequence of ball numbers thereon;
indicating each match between said ball numbers and said numbers on said number squares as each numbered ball is presented; and
determining game results based upon the numbers of said matches on each of said number cards.

2. The lotto type game set forth in claim 1 wherein said game further includes:
defining a second range of numbers;
randomly selecting a number of said second range of numbers;
presenting a plurality of letter-bearing balls interspersed among said numbered balls; and
determining a further game result based upon said number of letter-bearing balls presented.

3. The lotto type game set forth in claim 2 further including:
choosing the number of said number cards to be played; and
placing a wager determined by the number of number cards being played.

4. The lotto type game set forth in claim 3 further including placing a representation of each presented numbered ball into one of said numbered ball spaces.

5. The lotto type game set forth in claim 4 further including placing a representation of each presented letter-bearing ball into one of said lotto ball spaces.

6. The lotto type game set forth in claim 5 wherein said first range of numbers is one through twenty five inclusive.

7. The lotto type game set forth in claim 6 wherein said plurality of number squares on each of said number cards is equal to fifteen.

8. The lotto type game set forth in claim 7 wherein said second range of numbers is zero through five inclusive.

9. The lotto type game set forth in claim 8 wherein said plurality of number cards equals six.

10. The lotto type game set forth in claim 9 further including a bonus game result which requires that the player select all number cards for play and a predetermined game result.

11. A lotto type game constructed to be played on a game player having player input means and display means, said lotto game comprising:
displaying an image to the player which includes a plurality of number cards each having a plurality of randomly generated numbers;
displaying a plurality of numbered ball each having a randomly selected number thereon, said randomly generated numbers for said number cards and said randomly selected numbers for said numbered balls being selected from the same range of numbers;
indicating each match on said number cards for each numbered ball as it is displayed;
displaying a plurality of letter-bearing balls selected between zero and a predetermined maximum number randomly interspersed among said numbered balls;
placing a replica of each numbered ball presented upon said image;
determining a win or loose event for each number card based upon the number of said indicated matches on each card; and
indicating each number card having a winning number of matches thereon.

12. The lotto type game set forth in claim 11 further including:
choosing the number of said number cards to be played; and
placing a wager determined by the number of number cards being played.

13. The lotto type game set forth in claim 12 further including placing a representation of each presented numbered ball into one of said numbered ball spaces.

14. The lotto type game set forth in claim 13 further including placing a representation of each presented letter-bearing ball into one of said lotto ball spaces.

15. The lotto type game set forth in claim 14 wherein said plurality of number squares on each of said number cards is equal to fifteen.

16. The lotto type game set forth in claim 15 wherein said plurality of number cards equals six.

17. The lotto type game set forth in claim 16 further including a bonus game result which requires that the player select all number cards for play and a predetermined game result.

18. A lotto type game played upon a game player having user input means and display means, said lotto type game comprising:
a basic game, having defined basic game winning odds, played upon said game player;
a lotto game, having defined lotto game winning odds; and
player option, selected by user input, for playing said basic game alone at said basic game winning odds or for playing said basic game and said lotto game in combination at odds determined by the combination of said basic game winning odds and said lotto game winning odds.

19. The lotto type game set forth in claim 18 wherein said basic game includes:
providing an image having a ball presentation, a plurality of numbered ball spaces, a plurality of lotto ball spaces and a plurality of number cards each having a plurality of number squares thereon;
defining a first range of numbers;
randomly selecting a first plurality of numbers from said first range of numbers and placing said numbers on said number squares to fill said cards;
randomly selecting a second plurality of numbers from said first range of numbers to establish a sequence of ball numbers;
presenting a plurality of numbered balls upon said ball presentation, said numbered balls having said sequence of ball numbers thereon;
indicating each match between said ball numbers and said numbers on said number squares as each numbered ball is presented; and
determining basic game results based upon the numbers of said matches on each of said number cards.

20. The lotto type game set forth in claim 19 wherein said lotto game includes:
defining a second range of numbers;
randomly selecting a number of said second range of numbers;
presenting a plurality of letter-bearing balls interspersed among said numbered balls of said basic game; and
determining a further game result based upon said number of letter-bearing balls presented.

21. The lotto type game set forth in claim 20 further including:
choosing the number of said number cards to be played; and
placing a wager determined by the number of number cards being played.

22. The lotto type game set forth in claim 21 further including placing a representation of each presented numbered ball into one of said numbered ball spaces.

23. The lotto type game set forth in claim 22 further including placing a representation of each presented letter-bearing ball into one of said lotto ball spaces.

24. The lotto type game set forth in claim 23 wherein said first range of numbers is one through twenty five inclusive.

25. The lotto type game set forth in claim 24 wherein said plurality of number squares on each of said number cards is equal to fifteen.

26. The lotto type game set forth in claim 25 wherein said second range of numbers is zero through five inclusive.

27. The lotto type game set forth in claim 26 wherein said plurality of number cards equals six.

28. The lotto type game set forth in claim 27 further including a bonus game result which requires that the player select all number cards for play and a predetermined game result.
